(19) United States
(12) Patent Application Publication
(10) Pub. No.: US 2017/0212470 A1
(43) Pub. Date: Jul. 27, 2017

(54) METHOD FOR FORMING A MULTIPLE CHARGE GENERATING PHOTOREFRACTIVE POLYMER COMPOSITE FOR HOLOGRAM WRITING

(71) Applicant: University of Central Florida Research Foundation, Inc., Orlando, FL (US)

(72) Inventor: Jayan THOMAS, Orlando, FL (US)

(21) Appl. No.: 15/500,411

(22) PCT Filed: Jul. 29, 2015
(86) PCT No.: PCT/US15/42645

§ 371 Date: Jan. 30, 2017

Related U.S. Application Data
(60) Provisional application No. 62/030,225, filed on Jul. 29, 2014.

(51) Int. Cl. G03H 1/04; G02F 1/05; G11B 7/24044; C08K 3/30; C08K 3/04; G03H 1/12; G02F 1/39; G02F 1/055

(52) U.S. Cl. CPC G03H 1/04; G02F 1/397; G02F 1/0541; G02F 1/0558; C08K 3/30; C08K 3/042; C08K 3/045; G03H 1/12; G11B 7/24044; G03H 2001/0417; G03H 2001/0473; G03H 2260/54; G03H 2001/0415; C08K 2003/026

(57) ABSTRACT

A photorefractive (PR) polymer composite (310) is provided that includes a charge transporting polymer (CTP) matrix (311) and a photosensitizer (312) comprising a quantum dot (QD) material (314) with a first band gap (315) coupled to a nanoparticle material (317) with a second band gap (316) greater than the first band gap. The photosensitizer (312) is configured to generate a plurality of free charges (318) and to transfer the free charges to the CTP matrix (311) in response to an incident photon (320) on the PR polymer composite (310). An apparatus (500) is also provided, for writing holograms of 3D perspective views of an object from different directions within the PR polymer composite (310). A method (600) is also provided for forming the PR polymer composite.

### CROSS-REFERENCE TO RELATED APPLICATIONS

This application claims benefit of U.S. Provisional Application No. 62/030,225 filed Jul. 29, 2014, under 35 U.S.C. §119(e).

### BACKGROUND OF THE INVENTION

Photorefractive (PR) polymers have been used to generate holograms. During the hologram writing process, a pair of optical beams are directed at the PR polymer, and generate an interference pattern within the polymer. A sensitizer within the polymer generates free electrons and holes within the polymer, in response to the interference pattern. These free electrons and holes generate a space charge (SC) field, which causes an index pattern within the photorefractive polymer. The index pattern is then used with a readout beam corresponding to one of the optical beams to generate the holograms.

The sensitizers within current PR polymers have a quantum efficiency (QE) up to 100%, where QE is defined as the ratio of a number of generated free electrons within the polymer to the number of incident photons on the polymer. As a result, the minimum refresh rate in which the current polymers can generate the necessary index pattern is limited to approximately 2 seconds.

### SUMMARY OF THE INVENTION

The conventional PR polymer discussed above has some disadvantages. For example, the minimum refresh rate of 2 seconds is too long to generate holograms for video-rate 3D displays, which have a much shorter refresh rate of approximately 20-30 milliseconds (ms, 1 ms=10⁻³ seconds). In another example, although various applications have employed photoconducting polymers, such as solar cell applications, these applications do not apply an external electric field on the polymer and a refresh rate is irrelevant. In contrast, in PR polymer hologram applications, an external electric field is imposed, which speeds up the formation of the index pattern and thus shortens the refresh rate during the PR process. The embodiments disclosed herein are provided to eliminate one or more of these disadvantages.

In a first set of embodiments, a photorefractive (PR) polymer composite is provided that includes a charge transporting polymer (CTP) matrix and a photosensitizer comprising a quantum dot (QD) material with a first band gap coupled to a nanoparticle material with a second band gap greater than the first band gap. The photosensitizer is configured to generate a plurality of free charges and to transfer the free charges to the CTP matrix in response to an incident photon on the PR polymer composite.

In a second set of embodiments, an apparatus includes the PR polymer composite with the CTP matrix and the photosensitizer comprising the QD material with the first band gap coupled to the nanoparticle material with the second band gap greater than the first band gap. The apparatus also includes a pair of electrodes contacted to opposing sides of the PR polymer composite, to apply an external electric field across the PR polymer composite. The apparatus also includes a light modulator configured to receive image data of a plurality of 3D perspective views of an object from a plurality of fixed directions. The apparatus also includes a lens configured to focus an object beam transmitted through the light modulator for each 3D perspective view within the PR polymer composite from a first side of the PR polymer composite. The apparatus also includes a reference beam directed within the PR polymer composite at each fixed direction from a second side of the PR polymer composite opposite to the first side and configured to interfere with each object beam within the PR polymer composite to impress an index pattern within the PR polymer composite of the 3D perspective view of the object at each fixed direction.

In a third set of embodiments, a method is provided. The method includes combining the CTP matrix, a plasticizer, a non-linear optical (NLO) chromophore, and a quantum dot (QD) sensitizer in a solvent to form a mixture. The method further includes sonicating the mixture. The method further includes evaporating the solvent to obtain a composite. The method further includes melt processing the composite between a pair of electrodes to obtain a photorefractive polymer composite.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram that illustrates an example of a pair of interfering beams creating an interference pattern in a photorefractive (PR) polymer, according to an embodiment;

FIG. 1B is a block diagram that illustrates an example of charge separation within the PR polymer of FIG. 1A under an external electric field, according to an embodiment;

FIG. 1C is a block diagram that illustrates an example of index modulation in the PR polymer of FIG. 1B, according to an embodiment;

FIG. 2 is a graph that illustrates an example of plots of space-charge field magnitude versus trapped charge density in the PR polymer of FIG. 1B, according to an embodiment;

FIG. 3 is a block diagram that illustrates an example of a photorefractive (PR) polymer composite, according to one embodiment;

FIG. 4 is a block diagram that illustrates an example of an apparatus for measuring a quantum efficiency (QE) of a PR polymer composite, according to one embodiment;

FIG. 5 is a block diagram that illustrates an example of an apparatus for impressing an index pattern within the PR polymer composite of a plurality of 3D perspective views of an object, according to one embodiment;

FIG. 6 is a flowchart that illustrates an example of a method for forming a photorefractive polymer composite, according to one embodiment;

FIG. 7 illustrates an example of a transmission electron microscopy (TEM) image of an example quantum dot (QD) of the PR polymer of FIG. 3, according to an embodiment;

FIG. 8A is a block diagram that illustrates an example of single electron-hole pair formation, according to an embodiment;

FIG. 8B is a block diagram that illustrates an example of multiple electron-hole pair formation by impact ionization, according to an embodiment;

FIG. 9 is a block diagram that illustrates an example of an apparatus for measuring a quantum efficiency (QE) of a PR polymer composite, according to one embodiment;

FIG. 10 is a block diagram that illustrates an example of an apparatus for impressing an index pattern within the PR polymer composite of a plurality of 3D perspective views of an object, according to one embodiment;

FIG. 11 is a block diagram that illustrates an example of image processing taking place within the controller of FIG. 10, according to an embodiment;

FIG. 12 is a block diagram that illustrates an example of an apparatus for displaying a plurality of 3D perspective views of an object, according to one embodiment;

FIG. 13 is a block diagram that illustrates a computer system upon which an embodiment of the invention may be implemented; and

FIG. 14 is a block diagram that illustrates a chip set upon which an embodiment of the invention may be implemented.

### DETAILED DESCRIPTION

A method is described for forming a multiple charge generating photorefractive polymer composite that is used to write holograms. Additionally, an apparatus is described for writing holograms within the photorefractive polymer composite of a plurality of 3D perspective views of an object from a plurality of fixed directions. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of photorefractive polymer composites that are used to write holograms. However, the invention is not limited to this context. In other embodiments, the invention may be used for one or more of phase conjugation, optical correlation, image amplification, edge enhancement, novelty filtering and medical imaging.

### 1. Overview

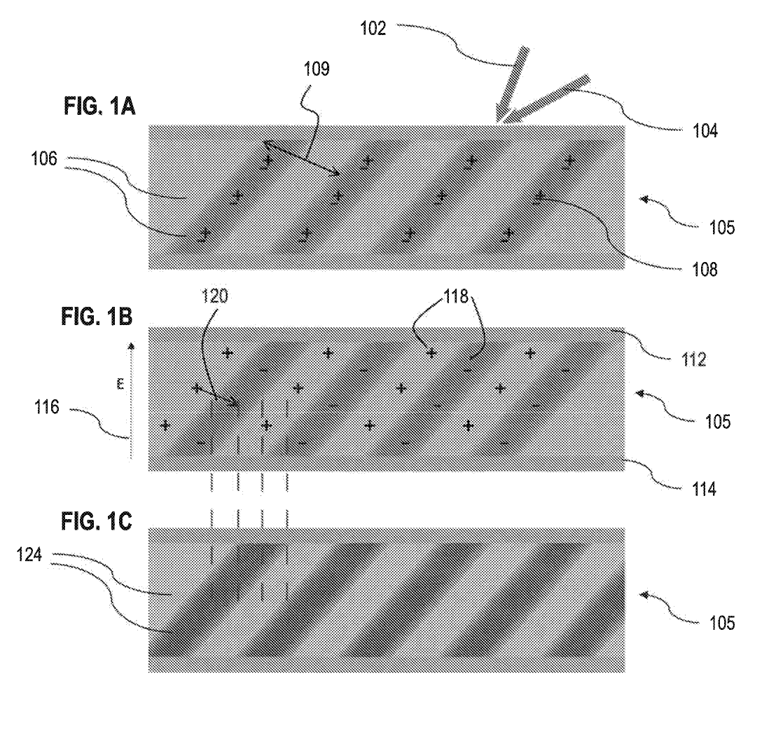

FIG. 1A is a block diagram that illustrates an example of a pair of interfering beams 102, 104 creating an interference pattern in a photorefractive (PR) polymer 105, according to an embodiment. When two coherent beams 102, 104 intersect within the PR polymer 105, a spatially modulated intensity pattern 106 is produced which is given by I(x):

$$I ( x ) = {I}_{o} [ 1 + {m}^{*} cos \frac{2 π}{Λ} ] \qquad ( 1 )$$

where Iₒ=I₁+I₂, I₁ is the intensity of beam 102 and I₂ is the intensity of beam 104; m is the fringe visibility given by:

$$m = \frac{2 \sqrt{{{I}_{1 }}^{*} {I}_{2}}}{( {I}_{1} + {I}_{2} )} \qquad ( 2 )$$

and Λ is the spatial wavelength 109 of the interference pattern, that is given by:

$$Λ = \frac{λ}{2 n sin [ \frac{{α}_{2} - {α}_{1}}{2} ]} \qquad ( 3 )$$

Where n is the refractive index of the material, λ is the optical wavelength in a vacuum, and α₁ and α₂ are the respective incident angles of the beams 102, 104 relative to the surface normal.

As depicted in FIG. 1A, as a result of the intensity pattern 106 with the wavelength 109, electron-hole pairs 108 are generated in high intensity regions. FIG. 1B is a block diagram that illustrates an example of charge separation within the PR polymer 105 of FIG. 1A under an external electric field 116, according to an embodiment. The external electric field 116 is applied between two electrodes 112, 114. Free charges (holes) of the electron-hole pairs 108 respond to the externally applied electric field 116, and move out of the high intensity region. This resulting charge separation creates trapped charges 118 and a space-charge field 120 is generated between the trapped charges 118 in the PR polymer 105.

FIG. 1C is a block diagram that illustrates an example of index modulation in the PR polymer 105 of FIG. 1B, according to an embodiment. As a result of the space-charge field 120 in the PR polymer 105 of FIG. 1B, an index modulation 124 is generated in the PR polymer 105. Since the space-charge field 120 generates the index modulation 124, a peak of the space-charge field 120 corresponds to an antinode of the index modulation 124, as depicted in FIG. 1C.

Sensitivity (S) of the PR polymer 105 is a measure of how well the beams 102, 104 are used during the recording of the index modulation 124. The sensitivity (S) of the PR polymer 105 is provided by:

$$S = \frac{\vert Δ n ( t ) \vert}{{{I}_{abs}}^{*} t} \qquad ( 4 )$$

Where Δn(t) is the index of modulation achieved in a time t, I_{abs} is the absorbed intensity of interfering beams 102, 104 within the PR polymer in time t. Based on equation (4), in order to generate the index modulation 124 in time t, the sensitivity S needs to be sufficiently large such that Δn(t) encompasses the index modulation 124 over the time t that the beams 102, 104 interfere. By increasing the sensitivity S, the required time t to generate the index modulation 124 is reduced and a refresh rate of the PR polymer 105 is enhanced. The index of modulation Δn is also related to the space-charge field 120 within the PR polymer 105, as provided by:

$$Δ n = - \frac{1}{2} {n}^{3} {r}_{eff} {E}_{sc} ( x ) \qquad ( 5 )$$

where E_{sc}(x) is the magnitude of the space-charge field 120 within the PR polymer 105, r_{eff} is the effective electro-optic (EO) coefficient within the PR polymer 105 and n is the refractive index of the material. Based on equation (5), the index of modulation Δn is directly proportional to the magnitude of the space-charge field 120 within the PR polymer 105. Based on equations (4) and (5), the sensitivity S is directly proportional to the magnitude of the space-charge field 120 within the PR polymer 105. Thus, increasing the magnitude of the space-charge field 120 within the PR polymer 105 would correspondingly increase the sensitivity S, reduce the time t to generate the index modulation 124 and thus enhance the refresh rate of the PR polymer 105.

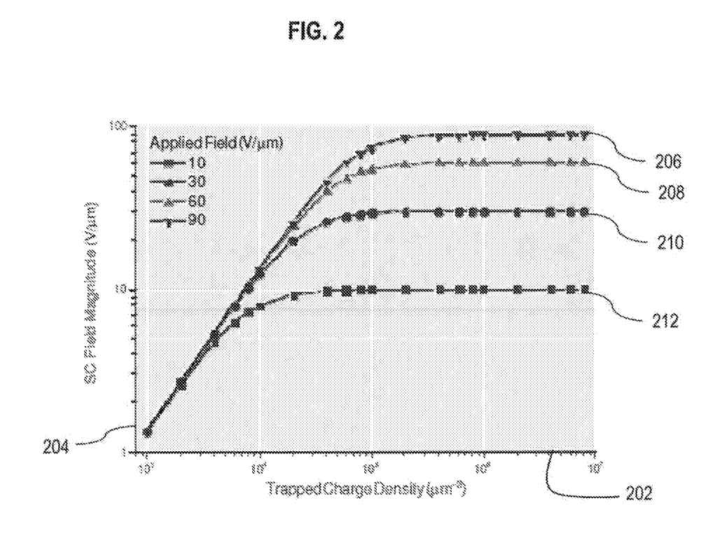

FIG. 2 is a graph that illustrates an example of curves of space-charge field magnitude versus trapped charge density, according to an embodiment. The horizontal axis 202 is the trapped charge density, measured in units of μm⁻³. The vertical axis 204 is the magnitude of the space-charge field magnitude, measured in units of volts per micron (V/μm). In an example embodiment, the trapped charge density is the density of the trapped charges 118 of FIG. 1B. In an example embodiment, the space-charge field magnitude is the magnitude of the space-charge field 120 depicted in FIG. 1B. The curves 206, 208, 210, 212 were generated for varying magnitudes of the electrical field 116, between 10-90 V/μm. As illustrated in FIG. 2, the space-charge field magnitude increases as the trapped charge density increases, up to a threshold trapped charge density of approximately 10⁵ μm⁻³, above which the space-charge field is relatively unchanged. Conventional PR polymers have a maximum trapped charge density of approximately 10³ μm⁻³. Based on FIG. 2, it is apparent that an increase in the trapped charge density above 10³ μm⁻³ would significantly increase the space-charge field 120 magnitude within the PR polymer 105, which would consequently reduce the time to generate the index modulation 124, as established above.

In an example embodiment, the trapped charge density within the PR polymer 105 can be increased, by increasing a quantum efficiency (QE) within the PR polymer 105, where QE is defined as the ratio of a number of generated trapped charges 118 within the polymer 105 to the number of incident photons from beams 102, 104 on the polymer 105. In conventional PR polymers, the QE is less than 100%, and thus the minimum refresh rate in conventional PR polymers is limited to approximately 2 seconds.

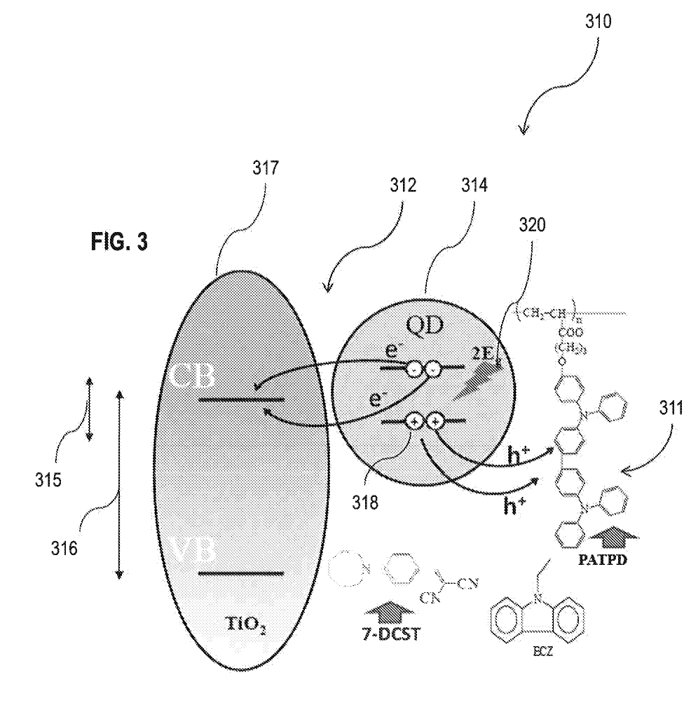

FIG. 3 is a block diagram that illustrates an example of a photorefractive (PR) polymer 310 that includes a charge transporting polymer (CTP) matrix 311 and a photosensitizer 312. In one embodiment, the photosensitizer 312 includes a quantum dot (QD) material 314 with a first band gap 315 and a nanoparticle material 317 with a second band gap 316 that is larger than the first band gap 315.

The first band gap 315 of the QD material 314 is adjusted such that an incident photon 320 on the PR polymer 310 energizes more than one electron to the conduction band, resulting in more than one free charge (holes) 318 within the QD material 314. As illustrated in FIG. 1, the free electrons in the QD material 314 transfer to a conduction band of the nanoparticle material 317 and the free charges (holes) 318 transfer to the CTP matrix 311. Since multiple electron/hole pairs are generated for each incident photon 320, the quantum efficiency (QE) of the PR polymer 310 is greater than 100%. In one embodiment, the first band gap 315 is adjusted such that the incident photon 320 energy is an integral multiple of the first band gap 315 energy, to generate multiple electrons/holes for each incident photon 320, resulting in a QE in excess of 100%. In one embodiment, the first band gap 315 is adjusted such that the incident photon 320 energy is twice the first band gap 315 energy, to generate two electrons/holes for each incident photon 320, resulting in a QE of 200%. In another embodiment, the first band gap 315 is adjusted such that the incident photon 320 energy is three times the first band gap 315 energy, to generate three electrons/holes for each incident photon 320, resulting in a QE of 300%. In another embodiment, the first band gap 315 is adjusted such that the incident photon 320 energy is four times the first band gap 315 energy, to generate four electrons/holes for each incident photon, resulting in a QE of 400%. When the QE of the PR polymer composite 310 is in excess of 100%, the space-charge field is generated at a faster rate, resulting in a shorter refresh rate for writing holograms during the hologram process.

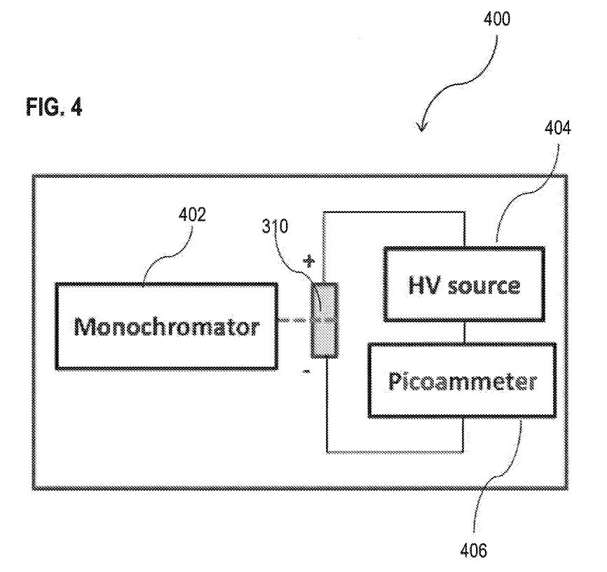

FIG. 4 is a block diagram that illustrates an example of an apparatus 400 for measuring the QE of the PR polymer composite 310. In one embodiment, the apparatus 400 includes a monochromator 402 which is a monochromatic optical source that outputs photons 320 incident on the PR polymer composite 310 at a selective energy. In one embodiment, the monochromator 402 outputs photons 320 with a wavelength in a range centered at a central wavelength. The monochromator 402 outputs photons 320 in a range of energy that includes at least one integral multiple of the first band gap 315 of the PR polymer composite 310.

As further illustrated in FIG. 4, a high voltage source 404 includes a pair of electrodes that are connected to the PR polymer composite 310, to apply an external electric field across the PR polymer composite 310. The external electric field across the PR polymer composite 310 facilitates the generation and transfer of the multiple electrons/holes within the PR polymer composite 310. As further illustrated in FIG. 4, a current meter 406, such as a picoammeter, is connected across the PR polymer composite 310, to measure a photocurrent generated in the PR polymer composite 310. In one embodiment, the measured photocurrent in the PR polymer composite 310 is used to determine the QE of the PR polymer composite 310. In one embodiment, the components of the apparatus 400 are controlled and monitored by software and hardware components as described in the Hardware Overview section below, in order to determine the QE of the PR polymer composite 310.

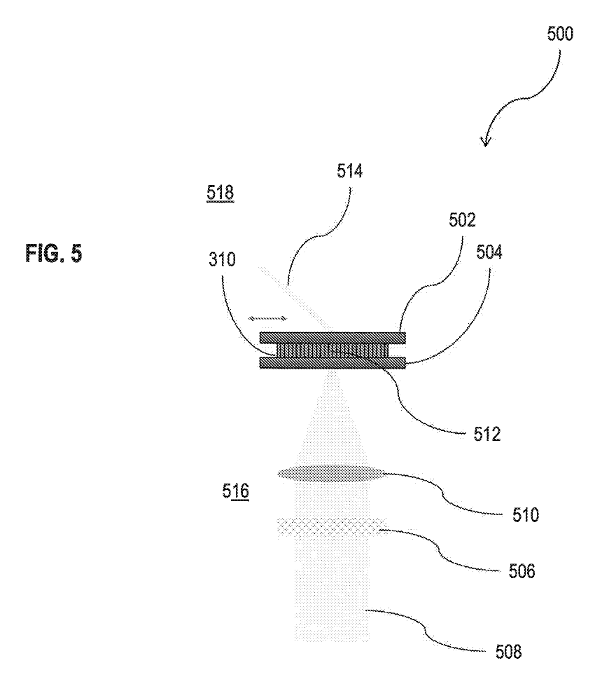

FIG. 5 is a block diagram of an apparatus 500 for recording index patterns within the PR polymer composite 310 based on a plurality of 3D perspective views of an object, as viewed from a plurality of fixed directions. The PR polymer composite 310 is positioned between a pair of electrodes 502, 504 that contact opposing sides of the PR polymer composite 310, to apply an external electric field across the PR polymer composite 310. Additionally, the apparatus 500 includes a light modulator 506 configured to receive image data of a plurality of 3D perspective views of an object from a plurality of fixed directions. After the image data of a first 3D perspective view from a first direction is uploaded to the light modulator 506, an object beam 508 is transmitted through the light modulator 506, which modulates the object beam 508 based on the first 3D perspective view data. A lens 510 then focuses the modulated object beam 508 within the PR polymer composite 310 from a first side 516 of the PR polymer composite 310. A reference beam 514 is directed within the PR polymer composite 310 at the first direction from a second side 518 of the PR polymer composite 310 that is opposite to the first side 516. Coherent interference between the reference beam 514 and the object beam 508 within the PR polymer composite 310 impresses an index pattern within the PR polymer composite 310 of the first 3D perspective view of the object at the first direction. After this index pattern is impressed within the PR polymer composite 310, image data of a second 3D perspective view of the object from a second direction is uploaded to the light modulator 506 and the above steps are repeated to impress an index pattern within the PR polymer composite 310 of the second 3D perspective view of the object at the second direction. These steps are repeated until each 3D perspective view of the object at each fixed direction has an impressed index pattern within the PR polymer composite 310. Since the QE of the PR polymer composite 310 is greater than 100%, the index patterns of each 3D perspective view are impressed within the PR polymer composite 310 in a shorter time frame than a PR polymer composite with a QE that is less than 100%.

After the holograms of each index pattern of the plurality of 3D perspective views at the fixed directions are recorded within the PR polymer composite 310, any of the holograms of the 3D perspective views of the object in a fixed directions may be viewed by directing a readout beam from the second side 518 of the PR polymer composite 310 in the fixed direction and observing a reflected beam from the PR polymer composite 310 in the fixed direction after the reflected beam undergoes diffraction within the PR polymer composite 310 based on the impressed index pattern for that 3D perspective view at that fixed direction.

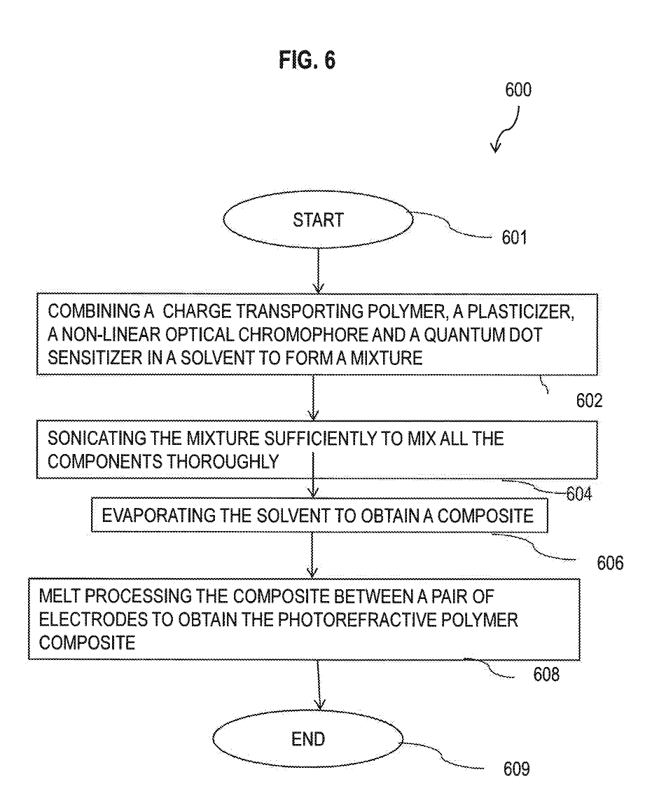

FIG. 6 is a block diagram that illustrates an example of a method 600 for forming the photorefractive polymer composite 310. Although the method is depicted as integral steps in a particular order for purposes of illustration, in other embodiments one or more steps, or portions thereof, are performed in a different order, or overlapping in time, in series or in parallel, or are deleted, or one or more other steps are added, or the method is changed in some combination of ways.

After start at block 601, in step 602 the CTP matrix 311, a plasticizer, a non-linear optical (NLO) chromophore and the QD sensitizer 312 are combined in a solvent to form a mixture. In step 604 the mixture is sonicated sufficiently to mix all the components thoroughly e.g. sonicate the mixture for approximately 30-60 minutes. In step 606, the solvent is evaporated (at a temperature in a range of approximately 50-120° C.) from the mixture to obtain a solid composite. In step 608, the composite is positioned between the electrodes of the high voltage source 404 and melt processed to obtain the photorefractive polymer composite 310, before the method ends at block 609.

### 2. Example Embodiments

According to an example embodiment, the QD material 314 is one of graphene, lead sulfide (PbS), lead selenide (PbSe) or indium phosphide (InP), or some combination. In another example embodiment, the nanoparticle material 317 is one of Titanium Dioxide (TiO₂), Zinc-oxide (ZnO) or Zinc-sulfide (ZnS) or some combination. In an example embodiment, the QD material 314 is determined, such that extraction of electrons to the conduction band of the nanoparticle material 317 occurs on time scales that are faster than Auger recombination (AR). In an example embodiment, material with a wide band gap 316 is selected for the nanoparticle material 317, to enable the transfer of electrons from the QD material 314 to the conduction band of the nanoparticle material 317 efficiently and rapidly before they recombine via. AR.

In an example embodiment, to form the photosensitizer 312, TiO² is used for the nanoparticle material 317 and attached to QD material 314 selected from one of PbS, PbSe and InP by using a surface chemistry strategy where a short-chain bifunctional passivation ligand like 3-mercaptopropionic acid (MPA) stabilizes the QD material 314 in water while chemically binding them. In an example embodiment, a first step of making TiO² attached PbS is the synthesis of oleic acid-capped PbS QD material. Lead oxide (PbO, 1.34 millimole or mmol) and oleic acid (12.6 mmol) are mixed in octadecene and heated to 1000° C. under a vacuum. After the PbO is dissolved, the temperature is increased to the nucleation temperature under nitrogen atmosphere to obtain the necessary particle size. Hexamethyldisilathiane (0.834 mmol) dissolved in octadecene in a separate flask is then injected into the above mixture to get PbS-oleate nanoparticles. A second step of making TiO² attached PbS then involves a ligand exchange reaction using MPA at the adjusted pH. The final step of making TiO² attached PbS is the attachment of anatase (TiO²). In an example embodiment, the anatase crystal will be polished, annealed, and treated with 10% aqueous hydrofluoric acid, followed by washing and treating with ligand exchanged QDs to get TiO² attached QD particles. The numerical parameters of the above steps, including the numerical amounts of each material (in mmol), numerical temperature and numerical acidic concentration, are merely exemplary and the above steps are not limited to these above numerical parameters. In an example embodiment, for incident photons 320 with a wavelength of 530 nm (i.e. incident photon energy of 2.33 eV), Ti0² attached QD particles are developed with a first band gap 315 where the incident photon energy is an integral multiple of first band gap 315, such as 0.59 eV, 0.77 eV and 1.175 eV corresponding to respective QE of 400%, 300% and 200%, respectively. In an example embodiment, photocurrent spectroscopy can be used to determine the first band gap 315. In an example embodiment, similar steps as those discussed above may be followed to develop Ti0² attached PbSe.

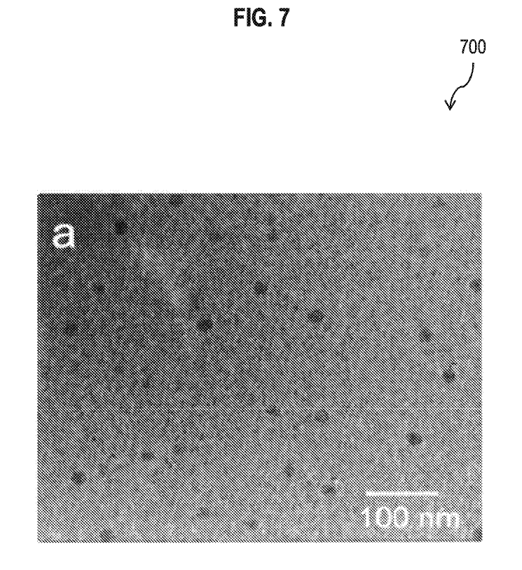

In an example embodiment, the photosensitizer 312 includes QD material 314 made of graphene and nanoparticle material 317 made of Titanium Dioxide (TiO₂), where the photosensitizer 312 is used to develop PR polymer composites sensitive at visible wavelengths. In an example embodiment, to form the photosensitizer 312, graphene oxide was synthesized by a modified Hummer's method and then dispersed in a solution of concentrated sulfuric acid and nitric acid using horn sonication for a predetermined time period. For example, an amount of graphene oxide in a range of 45-55 mg, such as 50 mg was used, an amount of sulfuric acid in a range of 70-80 ml, such as 75 ml was used, and an amount of nitric acid in a range of 20-30 ml, such as 25 ml, using Branson Digital Sonifier horn sonication at 9 W for a predetermined time in a range of 10-14 hours, such as 12 hours. In an example embodiment, a transparent yellow solution of QDs was obtained when this solution was refluxed at 210° C. for 24 hours followed by hydrazine reduction. FIG. 7 illustrates an example of a transmission electron microscopy (TEM) image 700 of an example of quantum dot (QD) material 314 made of graphene, which reveals a uniform particle size distribution.

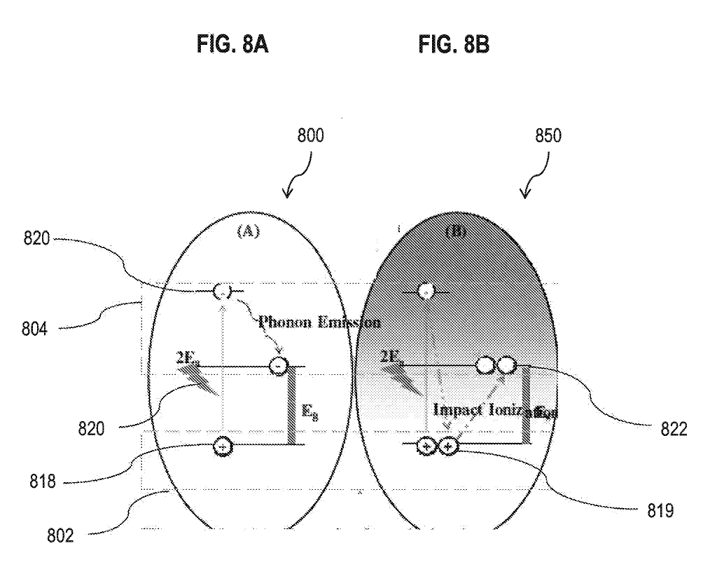

FIG. 8A is a block diagram that illustrates an example of single electron-hole pair formation in QD material, according to an embodiment. As illustrated in FIG. 8A, an incident photon 820 on QD material 800 has energy 2E_{g} equal to a gap between energy level 818 in the valance band 802 and energy level 820 in the conduction band 804 or twice the gap E_{g} between energy level 818 and energy level 822 in the conduction band 804. An electron transfers to energy level 820 in the conduction band 804, after which the electron emits a phonon, as it transits to energy level 822 in conduction band 804. As a result of photon 820 absorption in QD material 800, a single electron-hole pair is formed within QD material 800. FIG. 6B is a block diagram that illustrates an example of multiple electron-hole pair formation by impact ionization in QD material, according to an embodiment. The incident photon 820 with energy 2E_{g} excites a first electron to energy level 820 in the conduction band 804. Energy in an amount E_{g} is then transferred from the first electron at energy level 820 to a second electron at energy level 818 by coulomb interaction or impact ionization, thus exciting the second electron from energy level 818 in the valence band 802 to energy level 822 in the conduction band 804. The first electron transits down from energy level 820 to energy level 822 in the conduction band 804, as a result of the energy given off during the impact ionization. As a result of photon 820 absorption in QD material 850, multiple electron-hole pairs are formed within QD material 850, and thus the QE of the QD material 850 is greater than 100%. In an example embodiment, the multiple electron-hole pairs in the QD material 314 of the system 300 is formed by the coulomb interaction depicted in FIG. 6B.

In an example embodiment, the photosensitizer 312 includes QD material 314 made of graphene, which is considered as a zero band gap semiconductor with strong electron-electron interaction and ideal scattering channels that bridge the valence band (VB) and conduction band (CB) and can permit multiple electron-hole pair generation with a single photon. In an example embodiment, one characteristic of graphene which assists in generation of multiple electron-hole pairs is the reduction of energy gap to a single (Dirac) point in k-space which favors interband processes such as impact ionization depicted in FIG. 6B. In another example embodiment, an inefficient electron cooling in graphene can enhance the generation of multiple electron-hole pairs in graphene based optoelectronic devices and the QE of such optoelectronic devices can be greater than 100%. In another example embodiment, multiple electron-hole pairs can be generated in graphene even at a relatively low electric field.

In an example embodiment, the QD material 314 made from graphene includes a certain number of conjugated carbon atoms from small molecules. In an example embodiment, the QD material 314 made from graphene is provided with uniform and tunable size. In an example embodiment, the QD material 314 made from graphene is formed with carbon atoms varying from 170 to 276. In an example embodiment, QD material 314 made from graphene is obtained by oxidizing the dendritic precursor with excess of FeCl₃ in nitromethane/dichloromethane mixture. In the example embodiment, this oxidation of the dendritic precursors results in the fusion of the graphene moieties to give QDs of required size. In order to stabilize the QDs, 1, 3, 5 trialkyl phenyl groups will be attached to the edges. In an example embodiment, these alkyl chains increase the stability and solubility of the QDs. In an example embodiment, Poly(ethylene glycol) (PEG) and TPD groups are attached to the edges of QDs to increase the solubility in the solvent (e.g. toluene) used to dissolve the components for making PR composite. In order to introduce PEG and TPD to polyphenylene dendritic precursors, these groups will be attached to the building blocks of diaminobenzil and 4,4′-(ethyne-1,2-diyl)dianiline. In an example embodiment, a wide band gap nanoparticle material 317 like TiO² will be attached to QDs through functionalized diaminobenzil and 4,4′-(ethyne-1,2-diyl)dianiline. Additionally, dispersed graphene oxide (GO) sheets are reduced followed by a controlled reduction of hydrazine into QDs formed from graphene. In an example embodiment, the band gap of Vacuum Level 1.9 eV QDs will be controlled by either the size or the degree of reduction of GO sheets. In an example embodiment, the attachment of TPD on the QD surface is expected to transport holes to PATPD polymer matrix.

In an example embodiment, a surface of the QD material 314 is formed with InP and is modified with a wide band gap material such as ZnS, to form QD material 314 with a InP/ZnS core-shell. In an example embodiment, InP nanocrystals are synthesized first by using indium chloride, tristrimethylsilylphosphide and stabilizing agents. The size of QDs can be tuned by controlling the amount of stabilizing agents in solutions. In the example embodiment, the ZnS shell will be added to InP QDs through the heating of InP QDs with ZnS precursors such as bistrimethylsilylsulfide ((TMS)2S) and diethyl zinc (Et2Zn) or zinc diethyldithiocarbamate. In the example embodiment, the size, structure and optical properties of the developed QDs will be evaluated by TEM, UV-Vis spectroscopy and/or photoluminescence spectroscopy.

In an example embodiment, the incident photon 320 energy on the PR polymer composite 310 is 2.33 eV corresponding to a wavelength of 532 nm, and the first band gap 315 is adjusted to be one of 0.59 eV, 0.77 eV and 1.175 eV for a QE of 400%, 300% and 200%, respectively.

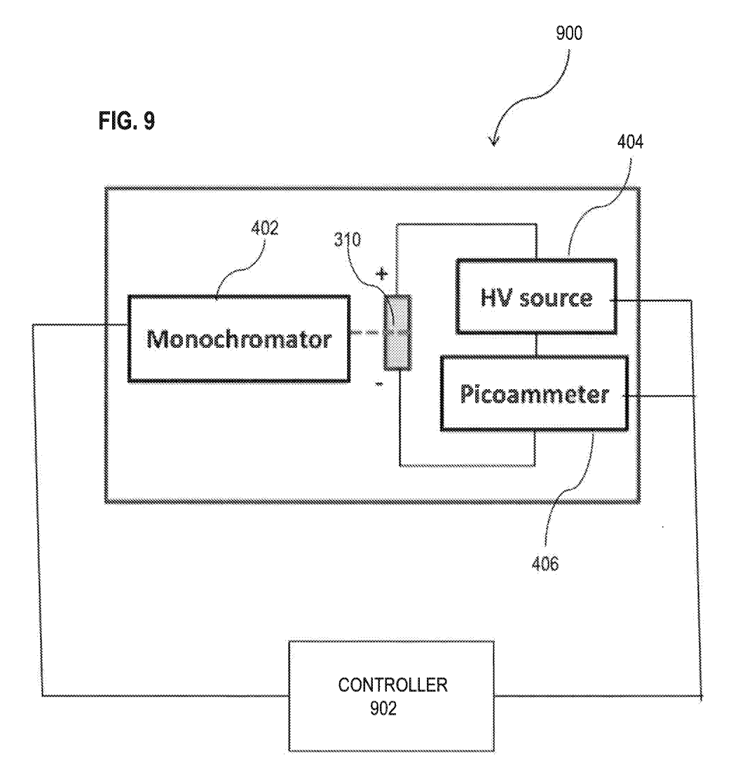

FIG. 9 is a block diagram that illustrates an example of an apparatus 900 for measuring a quantum efficiency (QE) of a PR polymer composite 310, according to one embodiment. In an example embodiment, the monochromator 402 outputs photons 320 at a range of wavelength centered on 532 nm. In an example embodiment, the monochromator outputs photons 320 in a range of 532 nm±50 nm. In another example embodiment, the monochromator outputs photons 320 in a range of 532 nm±10 nm. In another example embodiment, the monochromator 402 outputs photons 320 with energy in a range of 0.5-5 times the first band gap 315 energy. In an example embodiment, to evaluate the QE efficiency of the developed PR polymer composite 310 samples, a photoconductivity gain measurement is performed. A controller 902 is connected to the monochromator 402, HV source 404, and current meter 406. The controller 902 sends a signal to the HV source 404, to impart a voltage across the PR polymer composite 310. The controller 902 also transmits a signal to the monochromator 402, to output photons 320, such as at a wavelength that corresponds to about 0.5-5 times the first gap 315 of the QD material 314, such as a wavelength centered on 532 nm. The current meter 406 then detects a photocurrent generated within the PR polymer composite 310 and transmits the detected photocurrent to the controller 902. In an example embodiment, the controller 902 determines the QE of the PR polymer composite 310, based on the received photocurrent. In another example embodiment, the controller 902 determines the spectral responsivity, based on a ratio of the photocurrent to the incident light power, at a given illumination intensity range, such as between 2-20 nW/cm², for example. In another example embodiment, the controller 902 determines an internal photoconductive gain based on the spectral responsivity and an absorbance spectrum of the PR polymer composite 310.

In one example embodiment, multiple charge generation is observed in the PR polymer composite 310 when the photon 320 energy exceeds 2.7 times the first band gap 315 energy. In another example embodiment, the PR polymer composite 310 has a refresh rate of 20-30 ms.

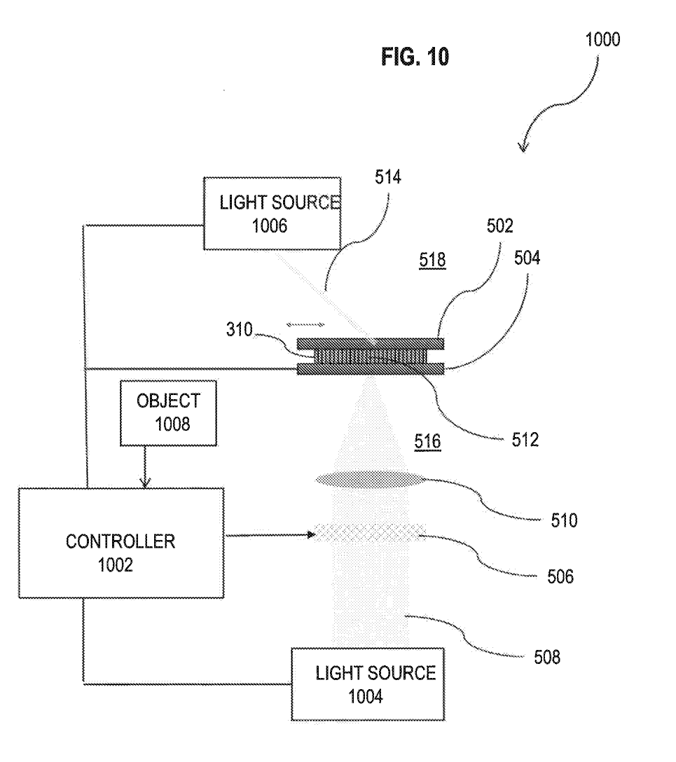

FIG. 10 is a block diagram that illustrates an example of an apparatus 1000 for impressing an index pattern within the PR polymer composite of a plurality of 3D perspective views of an object, according to one embodiment. The apparatus 1000 is similar to the apparatus 500 of FIG. 5, but includes a controller 1002 that is used to control various stages of operation of the apparatus 1000. In an example embodiment, the operations of the controller 1002 discussed herein are controlled and monitored by software and hardware components as described in the Hardware Overview section below, in order to impress an index pattern within the PR polymer composite 310 of a plurality of 3D perspective views of an object.

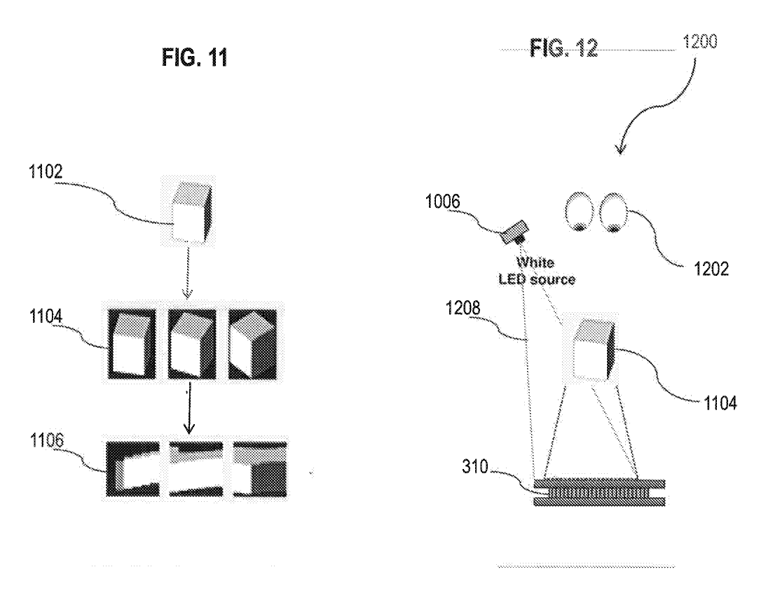

During an initial stage of operation of the apparatus 1000, an object 1008 is displayed and one or more 3D images of the object 1008 are inputted to the controller 1002, such using a camera coupled to the controller 1002. FIG. 11 is a block diagram that illustrates an example of image processing stages taking place within the controller 1002 of FIG. 10. As illustrated in FIG. 11, an image 1102 of the object 1008 is input to the controller 1002. The controller 1002 then generates a plurality of 3D views 1104 of the object 1008 from a plurality of fixed directions, based on the inputted image 1102 of the object 1008. Alternatively, a plurality of images of 3D views 1104 of the object 1008 from a plurality of fixed directions may be input to the controller 1002. The controller 1002 then divides each 3D view 1104 of the object into a plurality of portions 1106 of each 3D view 904 of the object 1008 from each fixed direction.

As illustrated in FIG. 10, the controller 1002 then transmits image data of a first portion 1106 of a first 3D view 1104 of the object 1008 from a first fixed direction to the light modulator 506. In an example embodiment, the controller 1002 is also connected to the electrodes 502, 504 and moves the electrodes 502, 504 until a desired cross-sectional area 512 of the PR polymer composite 310 to impress an index pattern of the first portion 1106 is in a focus region of the lens 510. The controller 1002 then transmits a signal to a light source 1004 to output the object beam 508 which is transmitted through the light modulator 506 after which the lens 510 focuses the modulated object beam 508 to the cross-sectional area 512 within the PR polymer composite 310. The controller 1002 also sends a signal to light source 1006 to output the reference beam 514 at the cross-sectional area 512 in the first fixed direction, where coherent interference between the reference beam 514 and the modulated object beam 508 at the cross-sectional area 512 impresses an index of refraction pattern of the first portion 1106 of the 3D perspective view 1104 at the cross-sectional area 512 within the PR polymer composite 310. This process is then repeated for each uploaded portion 1106 of the 3D perspective view 1104 in the fixed direction until an index of refraction pattern for the 3D perspective view 1104 in the fixed direction is impressed throughout the PR polymer composite 310. This process is then repeated for each portion 1106 of the next 3D perspective view 1104 in the next fixed direction, until the 3D perspective view in each fixed direction has an impressed index of refraction pattern within the PR polymer composite 310. Although FIG. 10 depicts separate light sources 1004, 1006 for the object beam 508 and reference beam 514, the object beam 508 and the reference beam 514 can be obtained by splitting a single laser beam into the opposing sides 516, 518 of the PR polymer composite.

FIG. 12 is a block diagram that illustrates an example of an apparatus 1200 for displaying a plurality of perspective views 1104 of an object 1008, according to one embodiment. After each index of refraction pattern has been impressed within the PR polymer composite 310 for each 3D perspective view 1104 in the plurality of fixed directions, an observer 1202 can view the 3D perspective views of the object. As illustrated in FIG. 12, the observer is positioned on the side 518 of the PR polymer composite 310 and the light source 1006 is used to transmit a beam 1208 in a first fixed direction at the PR polymer composite 310. Although FIG. 12 depicts that the light source 1006 used to transmit the reference beam 514 in FIG. 10 also transmits the beam 1208, a different light source may be used to transmit the beam 1208 than the light source 1006. The beam 1208 undergoes diffraction within the PR polymer composite 310 based on the impressed index pattern for the 3D perspective view 1104 at the first fixed direction. A reflected beam is then observed by the observer 1202 in the first fixed direction and the observer 1202 views the 3D perspective view 1104 of the object 1008 in the first fixed direction. To observe the object 1008 at different 3D perspective views, the light source 1006 transmits the beam 1208 at a second fixed direction and the observer 1202 observes the reflected beam at the second fixed direction, to view the 3D perspective view of the object 1008 in the second fixed direction.

### 3. Hardware Overview

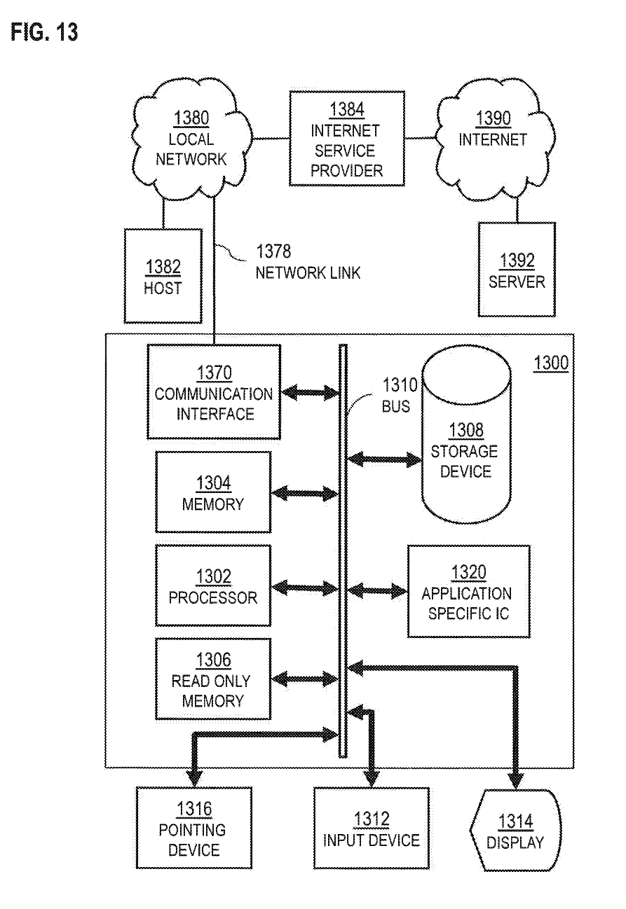

FIG. 13 is a block diagram that illustrates a computer system 1300 upon which an embodiment of the invention may be implemented. Computer system 1300 includes a communication mechanism such as a bus 1310 for passing information between other internal and external components of the computer system 1300. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit).). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of one or more methods described herein.

A sequence of binary digits constitutes digital data that is used to represent a number or code for a character. A bus 1310 includes many parallel conductors of information so that information is transferred quickly among devices coupled to the bus 1310. One or more processors 1302 for processing information are coupled with the bus 1310. A processor 1302 performs a set of operations on information. The set of operations include bringing information in from the bus 1310 and placing information on the bus 1310. The set of operations also typically include comparing two or more units of information, shifting positions of units of information, and combining two or more units of information, such as by addition or multiplication. A sequence of operations to be executed by the processor 1302 constitute computer instructions.

Computer system 1300 also includes a memory 1304 coupled to bus 1310. The memory 1304, such as a random access memory (RAM) or other dynamic storage device, stores information including computer instructions. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of computer instructions. The computer system 1300 also includes a read only memory (ROM) 1306 or other static storage device coupled to the bus 1310 for storing static information, including instructions, that is not changed by the computer system 1300. Also coupled to bus 1310 is a non-volatile (persistent) storage device 1308, such as a magnetic disk or optical disk, for storing information, including instructions, that persists even when the computer system 1300 is turned off or otherwise loses power.

Information, including instructions, is provided to the bus 1310 for use by the processor from an external input device 1312, such as a keyboard containing alphanumeric keys operated by a human user, or a sensor. A sensor detects conditions in its vicinity and transforms those detections into signals compatible with the signals used to represent information in computer system 1300. Other external devices coupled to bus 1310, used primarily for interacting with humans, include a display device 1314, such as a cathode ray tube (CRT) or a liquid crystal display (LCD), for presenting images, and a pointing device 1316, such as a mouse or a trackball or cursor direction keys, for controlling a position of a small cursor image presented on the display 1314 and issuing commands associated with graphical elements presented on the display 1314.

In the illustrated embodiment, special purpose hardware, such as an application specific integrated circuit (IC) 1320, is coupled to bus 1310. The special purpose hardware is configured to perform operations not performed by processor 1302 quickly enough for special purposes. Examples of application specific ICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1370 sends and receives electrical, acoustic or electromagnetic signals, including infrared and optical signals, that carry information streams, such as digital data.

The term computer-readable medium is used herein to refer to any medium that participates in providing information to processor 1302, including instructions for execution. Such a medium may take many forms, including, but not limited to, non-volatile media, volatile media and transmission media. Non-volatile media include, for example, optical or magnetic disks, such as storage device 1308. Volatile media include, for example, dynamic memory 1304. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1302, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1302, except for carrier waves and other signals.

Logic encoded in one or more tangible media includes one or both of processor instructions on a computer-readable storage media and special purpose hardware, such as ASIC 1320.

Network link 1378 typically provides information communication through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390. A computer called a server 1392 connected to the Internet provides a service in response to information received over the Internet. For example, server 1392 provides information representing video data for presentation at display 1314.

The invention is related to the use of computer system 1300 for implementing the techniques described herein. According to one embodiment of the invention, those techniques are performed by computer system 1300 in response to processor 1302 executing one or more sequences of one or more instructions contained in memory 1304. Such instructions, also called software and program code, may be read into memory 1304 from another computer-readable medium such as storage device 1308. Execution of the sequences of instructions contained in memory 1304 causes processor 1302 to perform the method steps described herein. In alternative embodiments, hardware, such as application specific integrated circuit 1320, may be used in place of or in combination with software to implement the invention. Thus, embodiments of the invention are not limited to any specific combination of hardware and software.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server 1392 transmits program code for a particular application, requested by a message sent from computer 1300, through Internet 1390, ISP equipment 1384, local network 1380 and communications interface 1370. The received code may be executed by processor 1302 as it is received, or may be stored in storage device 1308 or other non-volatile storage for later execution, or both. In this manner, computer system 1300 may obtain application program code in the form of a signal on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red a carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

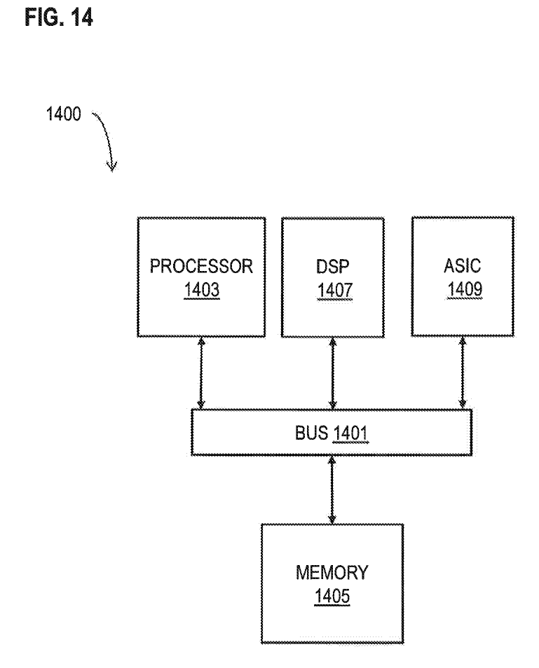

FIG. 14 illustrates a chip set 1400 upon which an embodiment of the invention may be implemented. Chip set 1400 is programmed to perform one or more steps of a method described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1400, or a portion thereof, constitutes a means for performing one or more steps of a method described herein.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 105 also stores the data associated with or generated by the execution of one or more steps of the methods described herein.

### 4. Extensions, Modifications and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1. A photorefractive polymer composite comprising:
a charge transporting polymer (CTP) matrix; and
a photosensitizer comprising a quantum dot (QD) material with a first band gap coupled to a nanoparticle material with a second band gap greater than the first band gap;
wherein the photosensitizer is configured to generate a plurality of free charges and to transfer the free charges to the CTP matrix in response to an incident photon on the polymer composite.

2. The photorefractive polymer composite of claim 1 wherein the QD material comprises one of Graphene, lead sulfide (PbS), lead selenide (PbSe) and indium phosphide (InP).

3. The photorefractive polymer composite of claim 1 wherein the nanoparticle material is one of TiO₂, ZnO and ZnS.

4. The photorefractive polymer composite of claim 1 wherein the first band gap of the QD material is configured such that an energy of each incident photon is an integral multiple of the first band gap.

5. The photorefractive polymer composite of claim 4 wherein the first band gap is configured such that the energy of each incident photon is up to 5 times the first band gap.

6. The photorefractive polymer composite of claim 1 wherein the first band gap of the QD material is configured such that an energy of each incident photon is at least 2.7 times the first band gap.

7. The photorefractive polymer composite of claim 4, wherein the energy of each incident photon is 2.33 eV and the first band gap is one of 0.59 eV, 0.77 eV and 1.175 eV.

8. The photorefractive polymer composite of claim 1 wherein the plurality of free charges are generated based on impact ionization in the QD material.

9. An apparatus comprising:
a photorefractive (PR) polymer composite including;
a charge transporting polymer (CTP) matrix, and
a photosensitizer comprising a quantum dot (QD) material with a first band gap coupled to a nanoparticle material with a second band gap greater than the first band gap,
a pair of electrodes contacted to opposing sides of the PR polymer composite to apply an external electric field across the PR polymer composite;
a light modulator configured to receive image data of a plurality of 3D perspective views of an object from a plurality of fixed directions;
a lens configured to focus an object beam transmitted through the light modulator for each 3D perspective view within the PR polymer composite from a first side of the PR polymer composite; and
a reference beam directed within the PR polymer composite at each fixed direction from a second side of the PR polymer composite opposite to the first side and to interfere with the object beam within the PR polymer composite to impress an index pattern within the PR polymer composite of the 3D perspective view of the object at each fixed direction.

10. The apparatus of claim 9 wherein the QD material comprises one of Graphene, lead sulfide (PbS), lead selenide (PbSe) and indium phosphide (InP).

11. The apparatus of claim 9 wherein the nanoparticle material is one of TiO₂, ZnO and ZnS.

12. The apparatus of claim 9 wherein the photosensitizer is configured to generate a plurality of free charges and to transfer the free charges to the CTP matrix in response to an incident photon on the polymer composite.

13. The apparatus of claim 12 wherein the first band gap of the QD material is configured such that an energy of each incident photon is an integral multiple of the first band gap.

14. The apparatus of claim 12 wherein the first band gap of the QD material is configured such that an energy of each incident photon is at least 2.7 times the first band gap.

15. The apparatus of claim 13 wherein the energy of each incident photon is 2.33 eV and the first band gap is one of 0.59 eV, 0.77 eV and 1.175 eV.

16. The apparatus of claim 9 wherein the light modulator is configured to receive image data of a portion of each 3D perspective view from each fixed direction and wherein the lens is configured to focus the object beam for the portion of each 3D perspective view to a cross-sectional area within the PR polymer composite.

17. The apparatus of claim 16 wherein the reference beam is to interfere with the object beam to impress the index pattern within the cross-sectional area of the PR polymer composite of the portion of the 3D perspective view from the fixed direction.

18. The apparatus of claim 9 wherein the reference beam and the object beam are obtained by splitting a single laser beam.

19. The apparatus of claim 9 wherein the plurality of 3D perspective views are generated from a single perspective view of the object.

20. A method comprising:
combining a charge transporting polymer (CTP), a plasticizer, a non-linear optical (NLO) chromophore, and a quantum dot (QD) sensitizer in a solvent to form a mixture;
sonicating the mixture;
evaporating the solvent to obtain a composite; and
melt processing the composite between a pair of electrodes to obtain a photorefractive polymer composite.
